(19) United States
(12) Patent Application Publication
(10) Pub. No.: US 2024/0158550 A1
(43) Pub. Date: May 16, 2024

(54) VINYL-CONTAINING AROMATIC ALICYCLIC COPOLYMER, RESIN COMPOSITION AND PRODUCT THEREOF

(71) Applicant: NAN YA PLASTICS CORPORATION, TAIPEI (TW)

(72) Inventors: Te-Chao Liao, TAIPEI (TW); Chi-Lin Chen, TAIPEI (TW)

(73) Assignee: NAN YA PLASTICS CORPORATION, TAIPEI (TW)

(21) Appl. No.: 18/075,420

(22) Filed: Dec. 6, 2022

(30) Foreign Application Priority Data
Oct. 28, 2022 (TW) 111141108

(51) Int. Cl. C08F 212/08; C08K 3/36; C08K 5/53; C08L 71/12

(52) U.S. Cl. CPC C08F 212/08; C08K 3/36; C08K 5/53; C08L 71/123; C08L 2205/03

(57) ABSTRACT

The disclosure provides a vinyl-containing aromatic alicyclic copolymer, a resin composition and a product thereof. The resin composition includes the vinyl-containing aromatic alicyclic copolymer, and the product made of the resin composition has a Tg of greater than 200° C., a dielectric constant Dk (10 GHz) of less than 3.0 and a dielectric loss Df (10 GHz) of less than 0.0014.

### CROSS-REFERENCE TO RELATED APPLICATION

This application claims the priority benefit of Taiwan application serial no. 111141108, filed on Oct. 28, 2022. The entirety of the above-mentioned patent application is hereby incorporated by reference herein and made a part of this specification.

### BACKGROUND

### Technical Field

The disclosure relates to a copolymer, a resin composition and a product thereof, and particularly relates to a vinyl-containing aromatic alicyclic copolymer, a resin composition and a product thereof.

### Description of Related Art

Generally, low-dielectric resins such as a liquid rubber have excellent dielectric properties, such as dielectric constant Dk and dielectric loss Df, and thus, they have become one of the desired choices for substrate materials of high-frequency printed circuit boards (PCBs).

However, a liquid rubber is a thermoplastic resin. Even though the liquid rubber is modified, the reactive groups thereof are relatively low. When such liquid rubber is directly applied to a copper foil substrate, following disadvantages such as (1) low Tg, (2) poor reactivity, (3) difficult processing, and (4) high melt viscosity may easily occur. Therefore, it is necessary to design a modified structure to meet the needs of printed circuit boards.

Based on the above, how to develop a material with excellent electrical properties and other PCB characteristics (e.g., high Tg, low expansion coefficient, and low water absorption) and therefore apply the material to the manufacture of a high-frequency substrate has become an urgent goal for those skilled in the art.

### SUMMARY

The disclosure provides a vinyl-containing aromatic alicyclic copolymer, a resin composition and a product thereof, and the product exhibits a high glass transition temperature, a low dielectric constant Dk and a low dielectric loss Df.

The vinyl-containing aromatic alicyclic copolymer of the disclosure includes a chemical structure represented by the following formula (1):

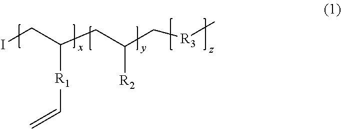

wherein in formula (1), x is an integer from 1 to 10, y is an integer from 1 to 20, z is an integer from 1 to 20;

R₁ is

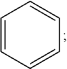

R₂ is

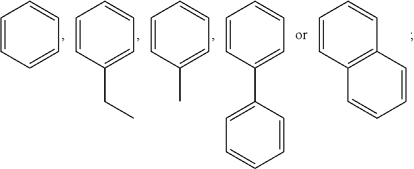

R₃ is one selected from the following chemical formulae:

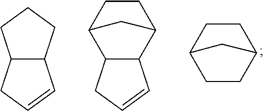

and
I is one selected from the following chemical formulae:

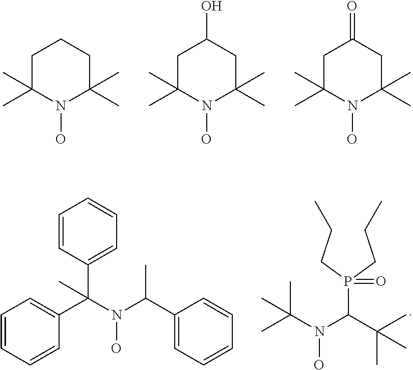

In an embodiment of the disclosure, a molecular weight Mn of the vinyl-containing aromatic alicyclic copolymer ranges from 2,000 to 6,000.

In an embodiment of the disclosure, in the vinyl-containing aromatic alicyclic copolymer, an alicyclic content is 10 mol % to 40 mol %, a vinyl content is 10 mol % to 40 mol %, and a styrene content is 20 mol % to 90 mol %.

The resin composition of the disclosure includes the above-mentioned vinyl-containing aromatic alicyclic copolymer, a polyphenylene ether resin, a triallyl isocyanurate, a bismaleimide resin, a flame retardant, and an inorganic filler.

In an embodiment of the disclosure, the flame retardant includes a phosphorus-based flame retardant.

In an embodiment of the disclosure, the inorganic filler includes silicon dioxide.

In an embodiment of the disclosure, based on a total weight of the resin composition, a content of the vinyl-containing aromatic alicyclic copolymer is 5 wt % to 20 wt %, and a content of the polyphenylene ether resin is 5 wt % to 30 wt %, a content of the triallyl isocyanurate is 5 wt % to 20 wt %, a content of the bismaleimide resin is 5 wt % to 20 wt %, a content of the flame retardant is 5 wt % to 20 wt %, and a content of the inorganic filler is 30 wt % to 60 wt %.

The product of the disclosure is made by processing the above-mentioned resin composition, and the processing includes impregnation and hot pressing.

In an embodiment of the disclosure, the product has a Tg of greater than 200° C., a dielectric constant Dk (10 GHz) of 3.0 or less, and a dielectric loss Df (10 GHz) of 0.0014 or less.

Based on the above, the disclosure provides a vinyl-containing aromatic alicyclic copolymer including reactive double bonds, and through intermolecular crosslinking, properties such as reactivity, heat resistance, chemical resistance, cold resistance properties, low temperature flexibility and electrical properties are improved, and the solvent solubility is increased. Moreover, the vinyl-containing aromatic alicyclic copolymer of the disclosure has a non-polar backbone structure, so it is not easily polarized in an electric field, and thus, the dielectric constant Dk (10 GHz) and dielectric loss Df (10 GHz) are greatly reduced, and the solvent solubility in acetone is 40%.

In order to make the above and other features and advantages of the disclosure more evident and easier to understand, the following embodiments are provided and represented in detail with the accompanying drawings as follows.

### DETAILED DESCRIPTION OF DISCLOSED EMBODIMENTS

Embodiments of the disclosure will be described in details below. However, these embodiments are illustrative, and the disclosure is not limited thereto.

Herein, a range indicated by “one value to another value” is a general representation which avoids enumerating all values in the range in the specification. Therefore, the description of a specific numerical range covers any numerical value within the numerical range and the smaller numerical range bounded by any numerical value within the numerical range, as if the arbitrary numerical value and the smaller numerical range are written in the specification.

The vinyl-containing aromatic alicyclic copolymer of the disclosure includes a chemical structure represented by the following formula (1):

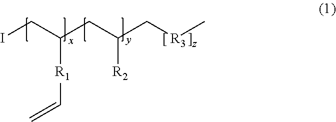

wherein in formula (1), x is an integer from 1 to 10, y is an integer from 1 to 20, z is an integer from 1 to 20;
R₁ is

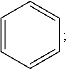

R₂ is

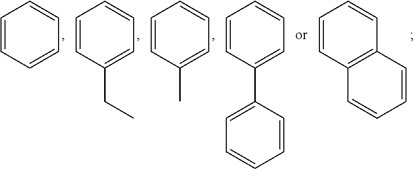

R₃ is one selected from the following chemical formulae:

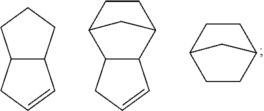

and
I is one selected from the following chemical formulae:

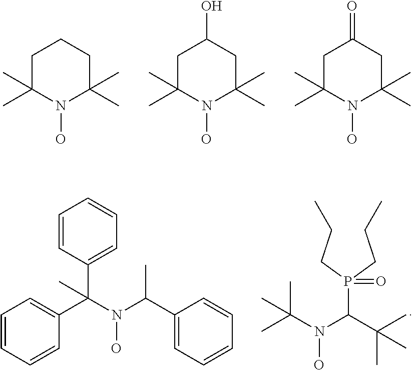

In this embodiment, a molecular weight Mn of the vinyl-containing aromatic alicyclic copolymer may be 2,000 to 6,000. In this embodiment, in the vinyl-containing aromatic alicyclic copolymer, an alicyclic content may be 10 mol % to 40 mol %, a vinyl content may be 10 mol % to 40 mol %, and a styrene content may be 20 mol % to 90 mol %.

In this embodiment, the manufacturing method of the vinyl-containing aromatic alicyclic copolymer may include a synthesis reaction process and a precipitation purification process, and the method may include the following steps. First, a reaction vessel is prepared, and a stirring mixer is provided inside. A free radical control agent, a free radical initiator and a reactive vinyl structure raw material are appropriately selected. The free radical control agent may include 2,2,6,6-tetramethylpiperidine-1-oxyl (TEMPO) compound or 4-hydroxy-2,2,6,6-tetramethylpiperidine-1-oxyl (4-hydoxy-TEMPO) compound, the free radical initiator may include benzoyl peroxide (BPO) or azobisisobutyronitrile (AIBN), and the reactive vinyl structure raw material may include 2-vinyl naphthalene, styrene, divinylbenzene (DVB), butadiene, 4-vinyl biphenyl, dicyclopentadiene (DCPD), norbornene, etc. In formula (1), I, x, y, and z are in a molar ratio (i.e., I:x:y:z) of 1:(2-5):(2-10):(2-10), I is a free radical scavenger, and x, y, and z are different kinds of reactive vinyl structures. The reaction is carried out in an aprotic solvent at a temperature of 0° C. to 150° C. for 1 hour to 5 hours, and the aprotic solvent may include toluene, dimethylformamide (DMF) or the like. The reaction solution is added with methanol to precipitate a solid, filtered, and vacuum-dried to obtain the vinyl-containing aromatic alicyclic copolymer of the disclosure.

The disclosure also provides a resin composition, which includes the above-mentioned vinyl-containing aromatic alicyclic copolymer, a polyphenylene ether resin, a triallyl isocyanurate, a bismaleimide resin, a flame retardant and an inorganic filler. In this embodiment, the flame retardant may include phosphorus-based flame retardant, and the inorganic filler may include silicon dioxide. In this embodiment, based on the total weight of the resin composition, the content of the vinyl-containing aromatic alicyclic copolymer may be 5 wt % to 20 wt %, and the content of the polyphenylene ether resin may be 5 wt % to 30 wt %, the content of triallyl isocyanurate may be 5 wt % to 20 wt %, the content of bismaleimide resin may be 5 wt % to 20 wt %, the content of the flame retardant may be 5 wt % to 20 wt %, and the content of the inorganic filler may be 30 wt % to 60 wt %.

The disclosure further provides a product, which is made by processing the resin composition described above, and the processing method may include impregnation and hot pressing. In this embodiment, the product may have a Tg of greater than 200° C., a dielectric constant Dk (10 GHz) of less than 3.0, and a dielectric loss Df (10 GHz) of less than 0.0014.

Hereinafter, the above-mentioned vinyl-containing aromatic alicyclic copolymer, resin composition and product thereof of the disclosure will be described in detail by means of experimental examples. However, the following experimental examples are not intended to limit the disclosure.

### Experimental Examples

The vinyl-containing aromatic alicyclic copolymer of the disclosure may improve the reactivity, heat resistance, chemical resistance, cold resistance, low-temperature flexibility and electrical properties of the product and increase the solvent solubility. Experimental examples are provided below for illustration.

Testing Methods
(1) “Glass transition temperature” is measured by using a thermogravimetric analyzer (TGA) to test the glass transition temperature of a rubber resin material.
(2) “Dielectric constant (10 GHz)” is measured by using a dielectric analyzer (model: HP Agilent E5071C) to test the dielectric constant of a rubber resin material at a frequency of 10 GHz.
(3) “Dielectric loss (10 GHz)” is measured by using a dielectric analyzer (model: HP Agilent E5071C) to test the dielectric loss of a rubber resin material at a frequency of 10 GHz.
(4) “Peel strength test” is implemented according to the IPC-TM-650-2.4.8 test method to test the peel strength of a metal substrate.
(5) “Heat resistance” indicates heating a metal substrate in a pressure cooker with a temperature of 120° C. and a pressure of 2 atm for 120 minutes, and then immersing the metal substrate in a soldering furnace at 288° C., and recording the time required for the explosion. When the explosion time exceeds 10 minutes, it is indicated by “OK”. When the explosion time is shorter than 10 minutes, it is indicated by “NG”.

Preparations of Vinyl-Containing Aromatic Alicyclic Copolymers

In below Table 1, the synthesis conditions of the vinyl-containing aromatic alicyclic copolymers of the disclosure are listed. The vinyl-containing aromatic alicyclic copolymers of Preparation Example 1 to Preparation Example 6 are prepared according to the synthesis conditions in Table 1.

TABLE 1

| | | Preparation | Preparation | Preparation | Preparation | Preparation | Preparation |
|---|---|---|---|---|---|---|---|
| | | Example 1 | Example 2 | Example 3 | Example 4 | Example 5 | Example 6 |
| Polymer | I | TEMPO | TEMPO | TEMPO | 4-hydroxy- | 4-hydroxy- | 4-hydroxy- |
| (molar | | 1(3.9 g) | 1(3.9 g) | 1(3.9 g) | TEMPO | TEMPO | TEMPO |
| ratio (g)) | | | | | 1(4.3 g) | 1(4.3 g) | 1(4.3 g) |
| | R₁ | DVB | DVB | butadiene | DVB | DVB | butadiene |
| | | 1(3.3 g) | 1(3.3 g) | 1(1.35 g) | 1(3.3 g) | 1(3.3 g) | 1(1.35 g) |
| | R₂ | styrene | 2-vinyl | 4-vinyl | styrene | styrene | 2-vinyl |
| | | 40(104 g) | naphthalene | biphenyl | 20(54 g) | 20(54 g) | naphthalene |
| | | | 15(57 g) | 10(45 g) | | | 10(38.5 g) |
| | R₃ | DCPD | DCPD | DCPD | norbornene | norbornene | norbornene |
| | | 2(6.6 g) | 3(9.9 g) | 1(3.3 g) | 1(2.35 g) | 2(4.7 g) | 1(2.35 g) |
| Solvent | | toluene | toluene | toluene | DMF | DMF | DMF |
| | | 500 ml | 500 ml | 500 ml | 500 ml | 500 ml | 500 ml |
| Catalyst | | BPO | BPO | BPO | AIBN | AIBN | AIBN |
| | | 6 g | 6 g | 6 g | 4 g | 4 g | 4 g |
| Reaction | pressure | normal | normal | normal | normal | normal | normal |
| conditions | | pressure | pressure | pressure | pressure | pressure | pressure |
| | temperature | 120° C. | 130° C. | 110° C. | 140° C. | 130° C. | 120° C. |
| | time | 3 hours | 3.5 hours | 4 hours | 2 hours | 4 hours | 4 hours |

### Preparation Examples

In Preparation Example 1, 3.9 g (equivalent to 0.025 mol) of TEMPO free radical control agent, 104 g (equivalent to 1 mol) of styrene, 6.6 g (equivalent to 0.05 mol) of DCPD, 3.3 g (equivalent to 0.025 mol) of DVB and 6 g (equivalent to 0.025 mol) of BPO initiator were selected in a molar ratio of 1:40:2:1:1. The above-mentioned raw materials were dissolved in 500 ml of toluene and put into a 1 L four-necked round-bottomed reaction flask equipped with a stirring mixer, nitrogen was introduced into the reaction flask to remove air and moisture, and the stirring mixer was started under normal pressure. The reaction solution was mixed evenly at 300 rpm. When the reaction temperature reached 120° C., all the solid contents in the reaction solution were dissolved into a clear reddish-brown solution. The reaction condition was set at a reaction temperature of 120° C. for 3 hours, so the clear reddish-brown solution was changed into a viscous reddish-brown solution. The solution was dropped into methanol to precipitate a polymer, and the obtained polymer was filtered and vacuum-dried to obtain the vinyl-containing aromatic alicyclic copolymer of the disclosure.

The vinyl-containing aromatic alicyclic copolymers of Preparation Example 2 to Preparation Example 6 were prepared in a method similar to the method described in Preparation Example 1.

### Experimental Examples and Comparative Examples

The vinyl-containing aromatic alicyclic copolymers of Preparation Examples 1-6 prepared in Table 1, and commercially available B1000, B2000 and RI257 resins were processed into copper foil substrates in the form of resin compositions, and the processing method can include impregnation and hot pressing. A glass fiber cloth was dipped into the rubber resin materials of Experimental Examples 1 to 6 and Comparative Examples 1 to 6 respectively, and after impregnation, drying and pressing, a prepreg can be obtained. The component ratios of the resin compositions and the test results of the copper foil substrates are listed in Table 2 below. As shown in Table 2, with the synthesis method of the vinyl-containing aromatic alicyclic copolymer of the disclosure, the resin PDI can be made between 1 and 1.4, and it is suitable for making a copper foil substrate having a high Tg of greater than 200° C., a dielectric constant Dk (10 GHz) of 3.0 or less and a dielectric loss Df (10 GHz) of 0.0014 or less.

The chemical structure of flame retardant DE60H is as follows:

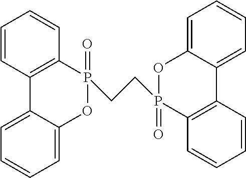 [SMILES: O=P1(CCP2(=O)Oc3ccccc3-c3ccccc32)Oc2ccccc2-c2ccccc21]

TABLE 2

| | | Experimental Example | | | | | |
|---|---|---|---|---|---|---|---|
| | | wt % | | | | | |
| | No. | 1 | 2 | 3 | 4 | 5 | 6 |
| Resin | polyphenylene | 19 | 19 | 19 | 19 | 19 | 19 |
| | ether resin | | | | | | |
| | SA9000 | | | | | | |
| | vinyl compound | 0 | 0 | 0 | 0 | 0 | 0 |
| | OPE-2st | | | | | | |
| | triallyl | 8.6 | 8.6 | 8.6 | 8.6 | 8.6 | 8.6 |
| | isocyanurate | | | | | | |
| | TAIC | | | | | | |
| | bismaleimide | 4.2 | 4.2 | 4.2 | 4.2 | 4.2 | 4.2 |
| | resin KI-70 | | | | | | |
| Liquid | B1000 | 0 | 0 | 0 | 0 | 0 | 0 |
| rubber | B2000 | 0 | 0 | 0 | 0 | 0 | 0 |
| | RI 257 | 0 | 0 | 0 | 0 | 0 | 0 |
| | Preparation | 11.2 | 0 | 0 | 0 | 0 | 0 |
| | Example 1 | | | | | | |
| | Preparation | 0 | 11.2 | 0 | 0 | 0 | 0 |
| | Example 2 | | | | | | |
| | Preparation | 0 | 0 | 11.2 | 0 | 0 | 0 |
| | Example 3 | | | | | | |
| | Preparation | 0 | 0 | 0 | 11.2 | 0 | 0 |
| | Example 4 | | | | | | |
| | Preparation | 0 | 0 | 0 | 0 | 11.2 | 0 |
| | Example 5 | | | | | | |
| | Preparation | 0 | 0 | 0 | 0 | 0 | 11.2 |
| | Example 6 | | | | | | |
| Flame | DE60H | 17 | 17 | 17 | 17 | 17 | 17 |
| retardant | | | | | | | |
| Inorganic | SiO₂ | 40 | 40 | 40 | 40 | 40 | 40 |
| filler | | | | | | | |
| Tg | | 210 | 208 | 220 | 215 | 202 | 217 |
| Dielectric constant | | 2.97 | 2.98 | 3.00 | 2.99 | 2.98 | 2.98 |
| Dk (10 GHz) | | | | | | | |
| Dielectric loss | | 0.0014 | 0.0014 | 0.0013 | 0.0014 | 0.0014 | 0.0014 |
| Df (10 GHz) | | | | | | | |
| Peel strength (Lb/in) | | 4.2 | 4.5 | 4.4 | 4.7 | 4.6 | 5 |
| Heat resistance | | OK | OK | OK | OK | OK | OK |
| | | Comparative Example | | | | | |
| | | wt % | | | | | |
| | No. | 1 | 2 | 3 | 4 | 5 | 6 |
| Resin | polyphenylene | 19 | 19 | 19 | 0 | 0 | 0 |
| | ether resin | | | | | | |
| | SA9000 | | | | | | |
| | vinyl compound | 0 | 0 | 0 | 19 | 19 | 19 |
| | OPE-2st | | | | | | |
| | triallyl | 8.6 | 8.6 | 8.6 | 8.6 | 8.6 | 8.6 |
| | isocyanurate | | | | | | |
| | TAIC | | | | | | |
| | bismaleimide | 4.2 | 4.2 | 4.2 | 4.2 | 4.2 | 4.2 |
| | resin KI-70 | | | | | | |
| Liquid | B1000 | 11.2 | 0 | 0 | 11.2 | 0 | 0 |
| rubber | B2000 | 0 | 11.2 | 0 | 0 | 11.2 | 0 |
| | RI 257 | 0 | 0 | 11.2 | 0 | 0 | 11.2 |
| | Preparation | 0 | 0 | 0 | 0 | 0 | 0 |
| | Example 1 | | | | | | |
| | Preparation | 0 | 0 | 0 | 0 | 0 | 0 |
| | Example 2 | | | | | | |
| | Preparation | 0 | 0 | 0 | 0 | 0 | 0 |
| | Example 3 | | | | | | |
| | Preparation | 0 | 0 | 0 | 0 | 0 | 0 |
| | Example 4 | | | | | | |
| | Preparation | 0 | 0 | 0 | 0 | 0 | 0 |
| | Example 5 | | | | | | |
| | Preparation | 0 | 0 | 0 | 0 | 0 | 0 |
| | Example 6 | | | | | | |
| Flame | DE60H | 17 | 17 | 17 | 17 | 17 | 17 |
| retardant | | | | | | | |
| Inorganic | SiO₂ | 40 | 40 | 40 | 40 | 40 | 40 |
| filler | | | | | | | |

| | | | | | | |
|---|---|---|---|---|---|---|
| Tg | 192 | 182 | 185 | 160 | 165 | 178 |
| Dielectric constant | 3.12 | 3.10 | 3.10 | 3.06 | 3.08 | 3.04 |
| Dk (10 GHz) | | | | | | |
| Dielectric loss | 0.0023 | 0.0026 | 0.0025 | 0.0024 | 0.0021 | 0.0022 |
| Df (10 GHz) | | | | | | |
| Peel strength (Lb/in) | 4.2 | 3.7 | 4.1 | 4.2 | 3.2 | 3.9 |
| Heat resistance | OK | OK | OK | OK | OK | OK |

In summary, based on the above, the disclosure provides a vinyl-containing aromatic alicyclic copolymer including reactive double bonds, and through intermolecular crosslinking, properties such as reactivity, heat resistance, chemical resistance, cold resistance properties, low temperature flexibility and electrical properties are improved, and the solvent solubility is increased. Moreover, the vinyl-containing aromatic alicyclic copolymer of the disclosure has a non-polar backbone structure, so it is not easily polarized in an electric field, and thus, the dielectric constant Dk (10 GHz) and dielectric loss Df (10 GHz) are greatly reduced, the dielectric constant Dk (10 GHz) is 3.0 or less, the dielectric loss Df (10 GHz) is less than 0.0014, and the solvent solubility in acetone is 40%. Therefore, the vinyl-containing aromatic alicyclic copolymer of the disclosure has excellent electrical properties and meets other characteristics requirements of printed circuit boards. As compared with general low-dielectric aromatic resins, the vinyl-containing aromatic alicyclic copolymers of the disclosure can improve brittleness, toughness, heat resistance and solvent solubility, and are suitable for making copper foil substrates having a high Tg of greater than 200° C., a dielectric constant Dk (10 GHz) of 3.0 or less and a dielectric loss Df (10 GHz) of 0.0014 or less. The vinyl-containing aromatic alicyclic copolymers of the disclosure are versatile and can be mixed with other resins and then hardened together, and the resulting products still exhibit improved properties such as high glass transition temperature (Tg), lower dielectric constant Dk and dielectric loss Df.

Although the disclosure has been disclosed as above with embodiments, they are not intended to limit the disclosure. People with ordinary skills in the art can make some changes and modifications without departing from the spirit of the disclosure, so the scope of the disclosure shall be defined by the following claims.

What is claimed is:

1. A vinyl-containing aromatic alicyclic copolymer, comprising a chemical structure represented by the following formula (1): 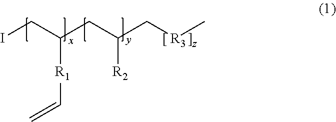
wherein in formula (1), x is an integer from 1 to 10, y is an integer from 1 to 20, z is an integer from 1 to 20;
R₁ is 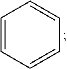
R₂ is 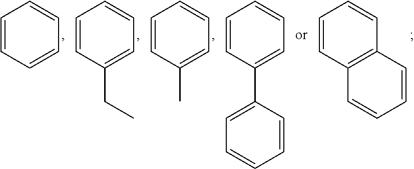
R₃ is one selected from the following chemical formulae: 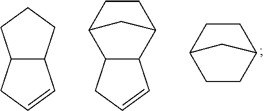
and
I is one selected from the following chemical formulae:

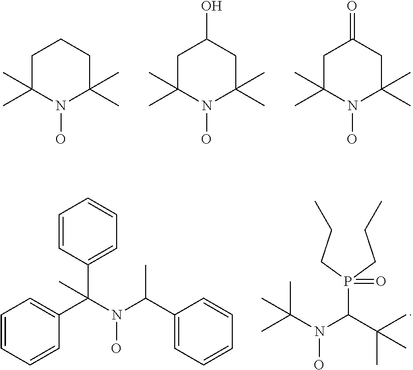

2. The vinyl-containing aromatic alicyclic copolymer of claim 1, wherein a molecular weight Mn of the vinyl-containing aromatic alicyclic copolymer ranges from 2,000 to 6,000.

3. The vinyl-containing aromatic alicyclic copolymer of claim 1, wherein in the vinyl-containing aromatic alicyclic copolymer, an alicyclic content is 10 mol % to 40 mol %, a vinyl content is 10 mol % to 40 mol %, and a styrene content is 20 mol % to 90 mol %.

4. A resin composition, comprising:
the vinyl-containing aromatic alicyclic copolymer of claim 1;
a polyphenylene ether resin;
a triallyl isocyanurate;
a bismaleimide resin;
a flame retardant; and
an inorganic filler.

5. The resin composition of claim 4, wherein the flame retardant comprises a phosphorus-based flame retardant.

6. The resin composition of claim 4, wherein the inorganic filler comprises silicon dioxide.

7. The resin composition of claim 4, wherein based on a total weight of the resin composition, a content of the vinyl-containing aromatic alicyclic copolymer is 5 wt % to 20 wt %, and a content of the polyphenylene ether resin is 5 wt % to 30 wt %, a content of the triallyl isocyanurate is 5 wt % to 20 wt %, a content of the bismaleimide resin is 5 wt % to 20 wt %, a content of the flame retardant is 5 wt % to 20 wt %, and a content of the inorganic filler is 30 wt % to 60 wt %.

8. A product made by processing the resin composition of claim 4, wherein the processing comprises impregnation and hot pressing.

9. The product of claim 8, wherein the product has a Tg of greater than 200° C., a dielectric constant Dk (10 GHz) of 3.0 or less, and a dielectric loss Df (10 GHz) of 0.0014 or less.
